(19) United States
(12) Patent Application Publication
(10) Pub. No.: US 2016/0188376 A1
(43) Pub. Date: Jun. 30, 2016

(54) Push/Pull Parallelization for Elasticity and Load Balance in Distributed Stream Processing Engines

(71) Applicant: Universidad de Santiago de Chile, Santiago (CL)

(72) Inventors: Erika ROSAS, Santiago (CL); Nicolas Hidalgo, Santiago (CL); Verónica Gil-COSTA, Santiago (CL)

(21) Appl. No.: 14/583,228

(22) Filed: Dec. 26, 2014

(51) Int. Cl. G06F 9/50

(52) U.S. Cl. CPC G06F 9/5083

(57) ABSTRACT

The stream processing engine uses the Actor programming paradigm for defining the application in terms of a graph built with processing elements (PEs) that use a hash based partitioning of data, where events (key, value) are pushed towards the next element in the operator, and in case of an overloaded PE the method changes to a Producer/Consumer Model where new workers pull events from a buffer queue in order to release the amount of traffic in the overloaded PE. The programmer defines a sequential version of the PE and other parallel version that recovers the events from a buffer and, if the operator is stateless sends the result to the next PE, or if the operator is stateful sends the result to an aggregator PE before moving to the next stage of the pipeline process. Strategies for triggering changes in the graph are defined in an administrator module to provide the right amount of elasticity and load balance in the distributed stream processing engine using queues analysis of the monitoring module.

### BACKGROUND OF THE INVENTION

### Field of the Invention

The present invention is in the field of systems, methods and computer program products for distributed stream processing applications that have to deal with changing traffic conditions and real time processing.

### BRIEF SUMMARY OF THE INVENTION

An embodiment of the invention is an elastic stream processing systems that can cope with changing traffic conditions alleviating load balancing issues due to unbalanced data distribution. The method is capable of adapting itself to different traffic conditions to avoid bottlenecks in the stream processing process.

The present invention includes a method for deciding when an operator is overloaded, determining which tuple (key, value) is unbalancing the traffic among the PEs and defining the number of processing elements that can cope with the traffic. The method is devised to adjust the role executed by the PEs according to the workload. The method includes: (1) a monitor module that analyses the number of events processed and the queue of events in each PE; (2) a method for changing from the push model, where operators send events to other operators, to the pull model where a defined set of operators pull events from the buffer of PEs; and (3) a method for determining when a given PE is overload and how to distribute its work among others PEs.

The monitor module is in charge of detecting overloaded PEs. It continuously checks the queue length of the PEs, controls the inter arrival time of events (L) and the service time (S). If the ratio L/u is greater than a threshold T, the monitor module emits an alert to be aware of the overload PE. If this overload situation continues for a period of time Δt, the “Administrator” module is executed. The overload PE keeps a buffer with the incoming events and becomes a producer. Some PEs selected from the pool of stateless PEs, are registered as consumers of the producer PE. The consumers inherit the tasks of the overload PE.

The method changes from the parallelization that use the push model with hash-based partition to the pull model where a defined set of operators pull events from the buffer of the overloaded PE. The push model sends the events to the next PE based on the key of the event. In the pull model, more similar to a producer/consumer model, the next PE in the graph requests the events to perform the processing task. This last model can partition the data according to the number of workers that consume the events which can be added on demand until the buffer queue stop growing.

An embodiment of the invention requires the programmer defines a parallelized version of the overload PE. If it is a stateless operator, there is no problem to use the same computation in the worker PEs that consume the events. However, if the PE is stateful, the parallel PEs perform the task independent and another aggregator PE joins the output of the workers in order to give the complete result.

BRIEF DESCRIPTION OF DRAWINGS

For a fuller understanding of the invention, reference should be made to the following detailed descriptions, taken in consideration with the accompanying drawings, in which:

FIG. 1 Is a diagrammatic view of the steps executed by the elastic model.

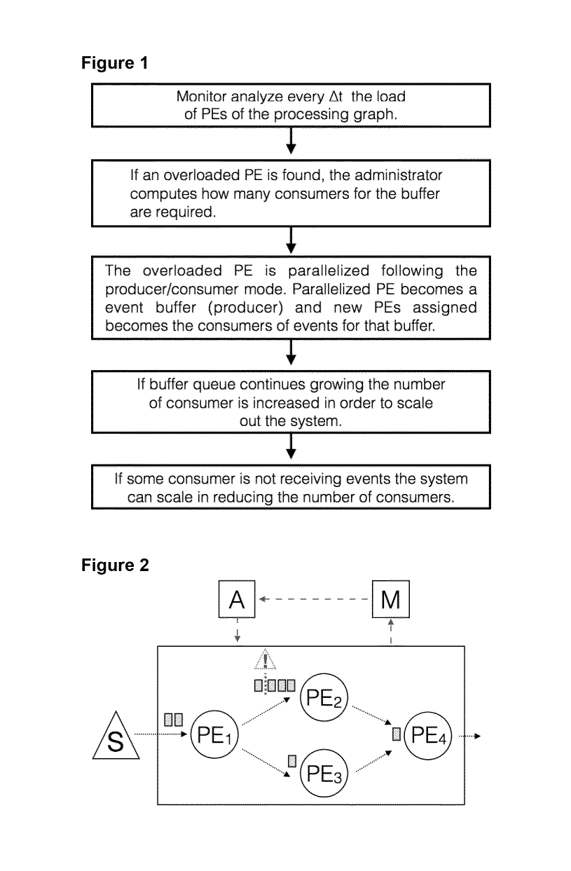

FIG. 2 Illustrates the components of the elastic model.

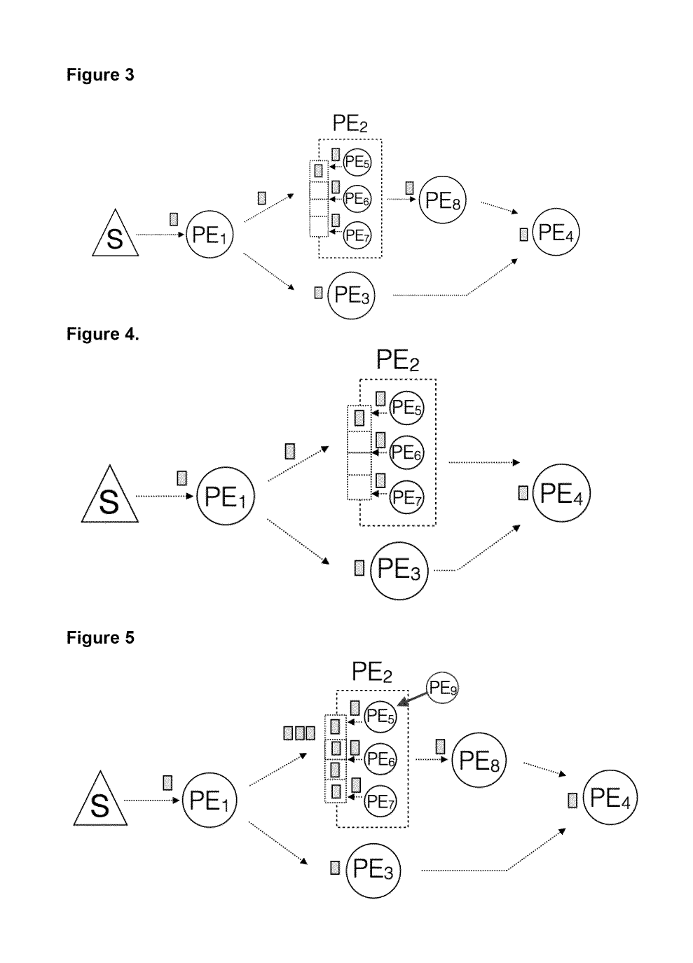

FIG. 3 Illustrates the parallelization of the stateful operator

FIG. 4 Illustrates the parallelization of the stateless operators.

FIG. 5 Illustrates the scale/out process with the pull model.

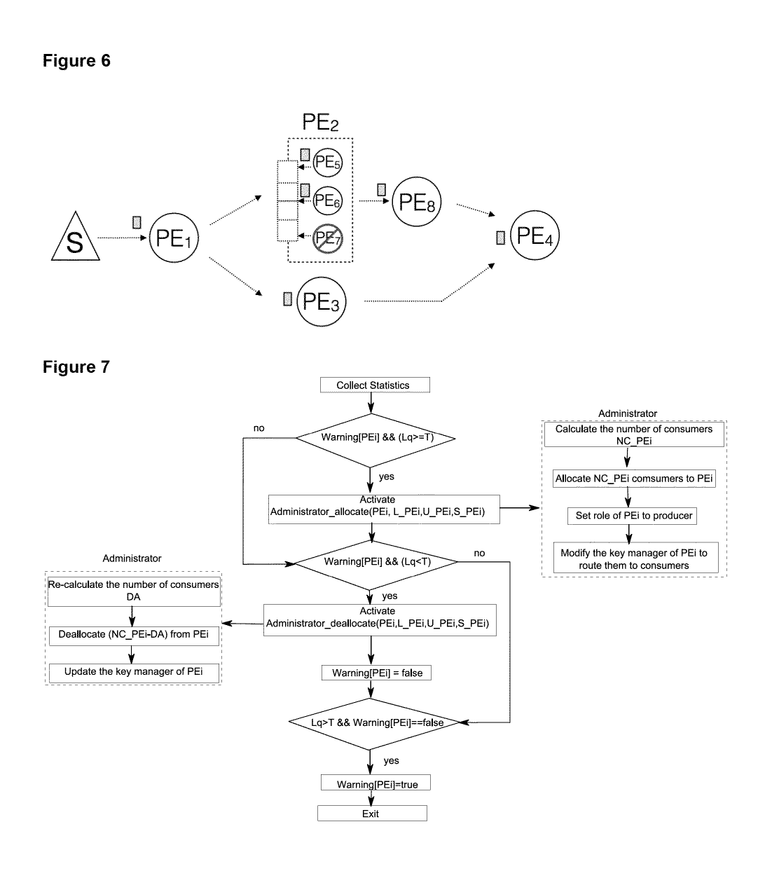

FIG. 6 Illustrates the scale in process with the pull model.

FIG. 7 Is a diagrammatic view of the steps executed by the monitor and the administrator modules.

### DETAILED DESCRIPTION OF THE PREFERRED EMBODIMENT

Provided is an elastic stream processing systems designed to cope with changing traffic conditions alleviating load balancing issues due to unbalanced data distribution. The method includes: (1) a monitor module that analyses the number of events processed and the queue of events in each PE; (2) a method for changing from the push model, where operators send events to other operators, to the pull model where a defined set of operators pull events from the buffer of PEs; and (3) a method for determining when a given PE is overload and how to distribute its work among others PEs.

Events are generated on-line in unpredictable time instants. The union of events forms a continuous stream of information that may have dynamic variations in intensity of traffic. In this context, the process used to store and organize/index events in a conveniently way to then process them in batch can be very costly given the huge volume of data and the amount of computational resources required for processing them. But even if this is feasible, it is often desirable or even imperative to process the events as soon as they are detected to deliver results in real time.

Stream processing corresponds to a distributed computing paradigm that supports the process of gathering and analyzing large volumes of heterogeneous data stream to assist decision making in real time. Each event is described as a pair (key, attribute). Processing elements (PEs) are the basic units and messages are exchanged between them. Each PE receives streams and processes them performing a primitive operation. Afterwards, the PE can generate one or more output streams. PEs are allocated in the so-called processing nodes (PNs) servers. The PNs are responsible for: a) receiving incoming events, b) routing the events to the corresponding PEs and c) dispatching events through the communication layer. The events are distributed using a hash function over the key of the events.

A monitor module collects statistics of the PEs every At units of times. Statistics include the length of the incoming events queue, the inter arrival time of events, the average service time required to process the incoming events and the utilization level. When the monitor module detects an overload PE, the warning alarm for the PE is ignited. No action is taken in this phase as the peak of work may be short-term, which does not justify activating any mechanism to reduce the workload in the PE.

If the overload PE persist after At units of times, the monitor activates the “administrator” procedure to calculate the number of consumer PEs assigned to alleviate the workload. The overload PE becomes a producer which holds a buffer with the incoming events and re-distributes them to the consumers.

FIG. 1 illustrates the components of the system, (1) the distributed stream processing systems, (2) a monitor M for detecting overloaded PEs and (3) an administrator A to parallelize the PE and define the number of consumer PEs to assign to alleviate the traffic. In the example of FIG. 1, data is produced by the source S and received by the first processing unit, PE1. PE1 splits its results based on their key which is generated with a hashing function. PE2 and PE3 are specialized to process one type of element or key. Due to the key distribution, traffic unbalance problems can arise. In the example of FIG. 1, PE2 becomes overloaded, while PE3 is working normally. PE2 has its queue of events growing since it cannot cope with the current traffic that PE1 is pushing towards him. The monitor M is the module that detects this situation by obtaining the queue size for each PE of the system. Periodically, the monitor M checks PE's queues searching for overloaded PE's. When the queue size reaches a given threshold, the monitor M execute a call to the administration module A in order to correct the load problem.

The administrator A is the module in charge of carrying out the parallelization of the PE. Using the information provided by the monitor, the administrator can estimate the number of resources required by the concerned PE. As the system is distributed across several machines the monitor M and the administrator A are also distributed across the machines.

FIG. 2 illustrates the parallelization of the PE2 triggered by the size of its processing queue. PE2 is a stateful operator which requires a special treatment to preserve the processing state when parallelizing. The administrator A, decides the number of additional resources or consumers associated to the concerned PE. The selected PE, PE2 changes to the producer mode where it acts as a buffer for events where consumers pull the events to process. The resources allocated by A (PE5, PE6 and PE7) are then associated to the PE2 buffer to consume events.

In this embodiment of the system, the PE2 is only the producer of the events and PE5, PE6 and PE7 pull the events of the buffer acting as consumers and performing the same task originally performed by PE2. In FIG. 2 PE2 is stateful, ie. the resulting state of the processing element after processing an event depends on the state of the PE and the other previous events. For example, the computation of a count of elements, or the average of an attribute. For these reason it is necessary to add an additional PE to aggregate partial results or the consumers (PE8). In FIG. 2, PE8 is the aggregation PE that receives the results of each PE worker and computes the results. The programmer requires having two versions of PE2, the normal and the parallel one used on the pull model.

FIG. 3 illustrates a simpler parallelization of PE2 which can be applied when the concerned PE is stateless, ie. the result produced by the PE does not depend on the previous processed events. In this case, it is not necessary to aggregate results so no additional PE is necessary. PE5, PE6 and PE7 can perform identical task as original PE2, while PE2 acts as a producer buffering the events for consumers. The latter pull the events from PE2 to consume them. Clearly, while more consumers are assigned by A, there is more parallelism and better performance is achieved.

FIG. 4 illustrates a scenario where the system must scale out in order to cope with the traffic.

Monitor M analyze every Δt the PE's queues or buffers if the PE is already parallelized. If the number of events on such structures reaches a given threshold the monitor must inform the administrator A about the load problem. In FIG. 4 the buffer of the producer, PE2, is full despite it is already parallelized, this means that the number of consumers assigned cannot cope with the total amount of traffic received. In such a case the system must scale out adding more consumer PEs in order to pull events faster. In FIG. 4 a new PE, PE9 is added to the set of consumers for PE2 stream. This step is very simple and there is no change to do in the way the events are handle by PE2. In other words, adding or removing consumers is transparent for the processing graph. This property allows this solution to not compromise performance when scaling in or scaling out. Scaling using a push model, requires to modify the hashing technique for events distribution. This solution can severely impact the system performance and increase data loss.

FIG. 5 illustrates the process of scale In, this process is important to optimize the resource usage. The dynamic behavior of traffic can require a higher amount of resources at a given time but later those assigned resources could be over dimensioned for the actual traffic. In order to improve the resource allocation the system must be able of deallocate resources that are not been used in order to assign it to those PE's who have a higher traffic demand. Both, scale in and scale out are processes triggered by the monitor M and managed by the administrator A. On scale in, monitor searches for lazy consumers. Once identified, it notifies the administrator in order to estimate how many consumers can be re allocated. The consumers selected are returned to a pool of consumers that the administrator controls. The PEs that consumes events from the buffer of PE2 has priorities for being served according to its ID. This cause the last PEs, in the example PE7, may not be able to pull out events from the buffer, since other PEs, in the example PE5 and PES have the computing power to process all the traffic, then PE7 is removed as a consumer for PE2.

FIG. 6 shows the steps executed by the monitor module to determine whether a PE is overload. After collecting the statistics, the monitor determines if the PEs are in warning mode and if the length of its queues are larger than a threshold T. If so, the administrator module is activated. Otherwise, the monitor checks if the warning mode of each PE (PEi) is already activated. If so, and it satisfies that the length of its queue is lower than the threshold T, the warning mode is turn off and consumers PEs are evicted from the PEi. Finally, the monitor module checks if the PEs are overloaded and their warning mode is off If so, the warning mode is turn on and the monitor module waits for Δt units of time to make a decision about allocating consumers to the overloaded PEs.

The administrator module A calculates the number of consumers to be allocated to an overloaded PE according to: NC_PEi=(1.0/U_PEi)*(L_PEi*S_PEi), where U_PEi is the utilization level of the overloaded PEi, L_PEi is the inter-arrival time of events and S_PEi is the average service time.

### Hardware and Software Infrastructure Examples

The present invention may be embodied on various multi-core computing platforms. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic magnetic, optical, electromagnetic, infrared, or semiconductor system, apparatus or device, or any suitable combination of the foregoing. More specific examples (a non-exhaustive list) of the computer readable storage medium would include the following: an electronic connection having one or more wires, a portable computer diskette, a hard disk, a random access memory (RAM), a read-only memory (ROM), an erasable programmable read-only memory (EPROM or Flash memory), an optical fiber, or any suitable combination of the foregoing. In the context of this document, a computer readable storage medium maybe any tangible medium that contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of variety of forms, including, but not limited to, electro-magnetic, optical, or any suitable combination thereof. A computer readable signal maybe any computer readable medium that is not computer readable storage medium, and that can communicate, propagate, or transport a program for use by or in connection with an instruction execution system, apparatus, or device.

Program code embodied on a computer readable medium maybe transmitted using any appropriate medium, including but not limited to, wire-line, optical fiber cable, radio frequency, etc., or any suitable combination of the foregoing. Computer program code for carrying out operations for aspects of the present invention may be writing in any combination of one or more programming languages, including an object oriented programming language such as Java, C++ or the like and conventional procedural programming languages such as the “C” programming language or similar programming languages.

Aspects of the present invention are described below with the reference to the flowchart illustration and/or block diagrams of methods, apparatus (systems) and computer program products according to the embodiments of the invention. It will be understood that each block of the flowchart illustrations and/or block diagrams, can be implemented by computer program instructions. These computer program instructions may be provided to a processor or a general purpose computer, or the programmable data processing apparatus to produce a machine, such that the instructions, which execute via the processor of the computer or other programmable data processing apparatus, creates means for implementing the functions/acts specified in the flowchart and/or block diagram block or blocks.

These computer programmable instructions may also be stored in a computer readable medium that can direct a computer, other programmable data processing apparatus, or other devices to function in a particular manner, such that the instructions stored in the computer readable medium produce an article of manufacturing including instructions which implement the function/act specified in the flowchart and/or block diagram block or blocks.

The computer program instructions may be also loaded onto a computer, other programmable data processing apparatus, or other devices to cause a series of operational steps to be performed on a computer, other programmable apparatus, or other devices to produce a computer implemented process such that the instructions which execute on the computer or other programmable apparatus provide process for implementing the functions/acts specified in the flowchart and/or block diagram block or blocks.

### Glossary of Claim Terms

Processing Elements (PE): Basic processing unit. These operators receive events, process them and emit new events.

Processing Nodes (PN): Physical processing processors hosting PEs.

Stream: Union of events forming a continuous stream of information.

Consumers: PEs receiving events from a producer PE. Events are processed and new events are emitted.

Producers: PEs holding a buffer of incoming events, which are re-routed to consumer PEs. No additional processing is performed on the events.

The advantages set forth and above, and those made apparent from the foregoing description, are efficiently attained. Since certain change may be made in the above construction without departing from the scope of the invention, it is intended that all matters contained in the foregoing description or shown in the accompanying drawings shall be interpreted as illustrative and not in a limiting sense.

What is claimed is:

1. The method for elastic distributed stream processing engines, with a system maintaining load balance for stateless and stateful operators, comprising the steps:
a. detecting overloaded operators (PEs);
b. if operators are overloaded, then allocating operators to those overloaded PEs by moving idle operators from a pool of stateless operators for parallelizing the overloaded operators; changing the role of the overloaded operator to producers; changing the role of assigned parallel operators to consumers; and
c. If operators are not overloaded and they have parallel operators already assigned, then deallocating parallel operators moving them back to the pool of stateless operators;
changing the role of producer operators to regular operator.

2. The method according to claim 1, wherein the system has the capability of self-monitoring the workload of the operators, their performance and make the appropriate change(s) to improve their response time and level of utilization; which further includes the following steps:
d. collecting statistics like the length of the queue of PEs, service time and level of utilization;
e. if the length of the queue is greater than a threshold T and the operator works on warning mode; then calculating the number of stateless PEs to be assigned as consumers of the overloaded PE (which becomes the producer); modifying the keys to re-route the events from the producer to the consumers PEs;
f. if the length of the queue is lower than a threshold T and the operator works on warning mode; then de-allocating PEs with low workload and changing the work mode of the PE from warning to normal; and
g. if the length of the queue is greater than a threshold T and the operator works on normal mode; then changing the work mode to warning.
